(19) United States
(12) Patent Application Publication
(10) Pub. No.: US 2025/0240687 A1
(43) Pub. Date: Jul. 24, 2025

(54) TECHNIQUE FOR MOBILITY BETWEEN TERRESTRIAL AND NON-TERRESTRIAL NETWORKS

(71) Applicant: Telefonaktiebolaget LM Ericsson (publ), Stockholm (SE)

(72) Inventors: Olof LIBERG, Enskede (SE); Emre YAVUZ, Stockholm (SE); Helka-Liina MÄÄTTÄNEN, Espoo (FI); Sebastian EULER, Storvreta (SE); Xingqin LIN, San Josè, CA (US)

(73) Assignee: Telefonaktiebolaget LM Ericsson (publ), Stockholm (SE)

(21) Appl. No.: 18/698,591

(22) PCT Filed: Oct. 10, 2022
(86) PCT No.: PCT/EP2022/078158

§ 371 Date: Apr. 4, 2024

Related U.S. Application Data
(60) Provisional application No. 63/253,974, filed on Oct. 8, 2021.

(51) Int. Cl. H04W 36/08; H04W 36/00; H04W 36/30

(52) U.S. Cl. CPC H04W 36/083; H04W 36/0061; H04W 36/30

(57) ABSTRACT

A technique for supporting mobility (602; 602′) of a radio device (100; 800; 1091; 1092; 1130) between a terrestrial network, TN (210), and a non-terrestrial network, NTN (500), is described. As to a method aspect of the technique performed by the radio device (100; 800; 1091; 1092; 1130), a control message (520) is received from at least one TN node (200; 900; 1012a; 1012c; 1120) of the TN (210) at the radio device (100; 800; 1091; 1092; 1130). The control message (520) is indicative of at least one NTN cell (512) of the NTN (500) for supporting the mobility (602) of the radio device (100; 800; 1091; 1092; 1130) between the TN (210) and the NTN (500).

### TECHNICAL FIELD

The present disclosure relates to a technique for mobility of radio devices between terrestrial and non-terrestrial networks. More specifically, and without limitation, methods and devices are provided for supporting mobility of a radio device between a terrestrial network and a non-terrestrial network.

### BACKGROUND

The Third Generation Partnership Project (3GPP) specified in 3GPP Release 8 the Evolved Packet System (EPS). EPS is based on a radio access network (RAN) according to 3GPP Long-Term Evolution (LTE) and a core network (CN) according to 3GPP Evolved Packet Core (EPC). It was originally intended to provide voice and mobile broadband (MBB) services but has continuously evolved to broaden its functionality. Since 3GPP Release 13, narrowband Internet of Things (NB-IoT) and LTE for machine-type communication (MTC or LTE-M) are part of the 3GPP specifications for LTE and provide connectivity to massive machine type communications (mMTC) services.

In 3GPP Release 15, the first release of a fifth generation (5G) system (5GS) was specified. This is a new generation's radio access technology (RAT) intended to serve use cases such as enhanced mobile broadband (eMBB), ultra-reliable and low latency communication (URLLC), and mMTC. The 5G RAT includes a New Radio (NR) access stratum (AS) interface and a 5G Core Network (5GC). The physical and higher layers of NR are reusing parts of the LTE specification, and to that add components, e.g., for use cases beyond LTE. One such component is the introduction of a sophisticated framework for beam forming and beam management to extend the support of the 3GPP technologies to a frequency range going beyond 6 GHz.

In Release 15, 3GPP started the work to prepare NR for operation in a non-terrestrial network (NTN). The work was conducted within the study item “NR to support Non-Terrestrial Networks”, e.g., according to 3GPP document RP-193234. In Release 16, the work to prepare NR for operation in an NTN network continued with the study item “Solutions for NR to support Non-Terrestrial Network”. In parallel the interest to adapt NB-IoT and LTE-M for operation in NTN is growing. As a consequence, 3GPP Release 17 contains work items both on NR NTN and on NB-IoT and LTE-M support for NTN.

However, for a radio device that is handed over from a terrestrial 3GPP network (TN) to connect to a 3GPP NTN, there currently exists limited support for achieving service continuity. This may result in a degraded end user performance.

### SUMMARY

Accordingly, there is a need for a technique that supports mobility between a terrestrial network and a non-terrestrial network.

As to a first method aspect, a method of supporting mobility of a radio device between a terrestrial network (TN) and a non-terrestrial network (NTN) according to claim 1 is provided. The method performed by the radio device comprises or initiates a step of receiving at least one of a control message from at least one TN node of the TN at the radio device and a control message from at least one NTN node of the NTN at the radio device. The control message from the at least one TN node is indicative of at least one NTN cell of the NTN for supporting the mobility of the radio device between the TN and the NTN. The control message from the at least one NTN node is indicative of at least one TN cell of the TN for supporting the mobility of the radio device between the TN and the NTN.

The first method aspect may be performed by the radio device.

By receiving the control message from the at least one TN node of the TN, at least some embodiments of the radio device can be supported in (e.g., assisted in and/or prepared for and/or configured for) the mobility between the TN and the NTN, e.g., from the TN to the NTN. Same or further embodiments of the radio device can, by receiving the control message from the at least one NTN node of the NTN, be supported in (e.g., assisted in and/or prepared for and/or configured for) the mobility between the TN and the NTN, e.g., from the NTN to the TN.

For example, the technique may be implemented in accordance with 3GPP and/or in an evolution of NTN in Release 18. At least some embodiments of the technique can enable NTN connectivity (i.e., radio access) provided by the NTN to complement terrestrial network connectivity (i.e., radio access provided by the TN). One example is that NTN may provide coverage over areas in which coverage by the TN is absent. For example, the technique may be specified in 3GPP Release 18 to address service continuity between connectivity provided by NTN and connectivity provided by TN.

In at least some embodiments, the control message may support the mobility of the radio device between the TN and the NTN. For example, the control message may assist the radio device in (e.g., during) a handover from the TN to the NTN and/or from the NTN to the TN.

The TN may refer to a radio access network (RAN), or a segment of a RAN, using one or multiple terrestrial (e.g., ground-based and/or stationary) network nodes (TN nodes, e.g., TN base stations). The one or multiple TN nodes may comprise one or multiple network nodes that are located on and/or supported by a surface of Earth, Mars or any other planet.

The at least one NTN node may comprise one or multiple airborne vehicles and/or one or multiple spaceborne vehicles.

The NTN may refer to a RAN, or a segment of a RAN, using one or multiple non-terrestrial vehicles as non-terrestrial network nodes (NTN nodes, e.g., NTN base stations), e.g., for at least one of radio transmission, radio reception, and providing radio access. The non-terrestrial radio access vehicles may comprise one or multiple airborne vehicles and/or one or multiple spaceborne vehicles. Herein, airborne may refer to an atmosphere of the respective planet (e.g., not limited to air). Airborne may mean supported by and/or located in the atmosphere. Alternatively or in addition, spaceborne may mean moving according to celestial mechanics and/or located in (e.g., outer) space.

The airborne vehicles may comprise one or more High Altitude Platforms (HAPs), e.g., Unmanned Aircraft Systems (UAS), optionally including tethered UAS, Lighter than Air UAS, and Heavier than Air UAS. The HAPs may operate at an altitude between 8 km and 50 km and/or quasi-stationary.

The spaceborne (also: written space-borne) vehicles may comprise one or more satellites, e.g., any device in orbit around the respective planet. The spaceborne vehicles may be in low earth orbit (LEO), medium earth orbit (MEO) or geostationary earth orbit (GEO).

The TN and the NTN may be segments of a RAN. Alternatively or in addition, a feeder link (also referred to as: radio access link) may wirelessly connect the NTN (e.g., the at least one NTN node) and the TN (e.g., to the at least one TN node). Alternatively, the TN and the NTN may be two RANs connected to same core network (CN). For example, the feeder link may connect the CN and the NTN.

The TN (e.g., one or each of the at least one TN node) may be configured to serve (i.e., provide radio access to) the radio device, e.g., in one or multiple TN cells. This may also be referred to as the at least one TN node serving the one or multiple TN cells. Alternatively or in addition, the NTN (e.g., one or each of at least one NTN node of the NTN) may be configured to serve (i.e., provide radio access to) the radio device, e.g., in one or multiple NTN cells. This may also be referred to as the at least one NTN node serving the one or multiple NTN cells. Each cell of the TN and/or each cell of the NTN may correspond to a coverage area (e.g., on the surface of respective planet). Optionally, the coverage area of the NTN cell of one or each of the at least NTN node may be movably controlled (e.g., steerable) by the respective NTN node.

The mobility between the TN and the NTN may comprise the radio device moving from a TN cell of the TN to an NTN cell of the NTN or from an NTN cell of the NTN to a TN cell of the TN.

Alternatively or in addition, the mobility may encompass the radio device selecting (e.g., re-selecting) an NTN cell of the NTN in an idle state of the radio device, optionally wherein the selected (e.g., re-selected) NTN cell is an NTN cell of the at least one NTN node. Alternatively or in addition, the mobility may encompass the radio device initiating a connection resume procedure (e.g., transmitting an RRC connection resume) in an inactive state of the radio device, optionally wherein the connection resume is transmitted to the at least one NTN node serving the at least one NTN cell. Alternatively or in addition, the mobility may encompass the radio device radio device performing a location-update procedure that enables the TN and/or the NTN to update a Radio Access Network (RAN) Notification Area (RNA) assigned to the radio device. Alternatively or in addition, the mobility may encompass the radio device being handed over from the at least one TN node (or from a TN cell of the at least one TN node) to the at least one NTN node (or to the at least one NTN cell), or from the at least one NTN node (or from the at least one NTN cell) to the at least one TN node (or to a TN cell of the at least one TN node). The at least one TN node of the TN (e.g., according to the first method aspect) may provide radio access in at least one TN cell. Alternatively or in addition, at least one NTN node of the NTN may provide radio access in the at least one NTN cell. Alternatively or in addition, the control message may be indicative of at least one of a position of one or each of the at least one NTN node; a velocity of one or each of the at least one NTN node; a trajectory of one or each of the at least one NTN node; a coverage area covered by one or each of the at least one NTN node, optionally at least one of a reference point of the coverage area, a center of the coverage area, and a size of the coverage area; a coverage area covered by one or each of the at least one NTN cell, optionally at least one of a reference point of the coverage area, a center of the coverage area, and a size of the coverage area; a cell identifier, cell ID, and/or a carrier frequency of one or each of the at least one NTN node or one or each of the at least one NTN cell; a handover command for a handover of the radio device from the at least one TN node or the at least one TN cell to the at least one NTN node or the at least one NTN cell; a handover command for a handover of the radio device from the at least one NTN node or the at least one NTN cell to the at least one TN node or the at least one TN cell; a position of the radio device, optionally relative to the at least one NTN node; an elevation angle and/or azimuth angle for an uplink transmission from the radio device to the at least one NTN node and/or a downlink reception from the at least one NTN node at the radio device; a timing advance (TA) or a pre-compensation of the TA, for an uplink transmission from the radio device to the at least one NTN node; and a precoder for a beamformed transmission from the radio device to the at least one NTN node.

The radio device may receive the control message in a serving TN cell of the TN and/or the at least one TN node may be or comprise a serving TN node of the radio device.

The trajectory (e.g., a flight path or an orbit) of the respective NTN node may also be referred to as an ephemeris (or plural: ephemerides) or ephemeris data, i.e., data that may be indicative of a trajectory of the respective airborne or spaceborne vehicle embodying the NTN node. Alternatively or in addition, the control message may be indicative of at least one of a position and a velocity of the respective NTN node, e.g., over time (e.g., at periodic points in time).

The coverage area covered by one or each of the at least one NTN node may be the area (e.g., on the surface of the respective planet) in which the respective NTN node is configured to provide the radio access. In other words, the NTN node can provide the radio access when the radio device is in the coverage area. The coverage area of the respective NTN node may also be referred to as the NTN cell (e.g., a beam spot) of the respective NTN node. Furthermore, the expressions NTN cell and NTN node may be used interchangeably. For example, a transmission or reception in an NTN cell may refer to a transmission to or reception from the NTN node serving the respective NTN cell.

One or each of the at least one NTN cell may be a target cell of the mobility (e.g., of the handover). Alternatively or in addition, one or each of the at least one NTN node may be a target node of the mobility (e.g., of the handover). Alternatively or in addition, one or each of the at least one TN cell may be a source cell of the mobility (e.g., of the handover). Alternatively or in addition, one or each of the at least one TN node may be a source node of the mobility (e.g., of the handover).

The radio device may compute (e.g., for the uplink transmission from the radio device to the at least one NTN node and/or the downlink reception from the at least one NTN node to the radio device), based on the control message, at least one of the TA, the pre-compensation (e.g., a course estimate) of the TA, the precoder, the elevation angle, and the azimuth angle.

The at least one TN cell (e.g., according to the first method aspect) may be serving the radio device. Alternatively or in addition, the at least one TN node may be a serving node of the radio device. Alternatively or in addition, the at least one TN cell and the at least one NTN cell are neighboring cells or overlapping cells.

A TN cell of the at least one TN node (e.g., the serving TN cell) and one or each of the at least one NTN cell may be neighboring cells or overlapping cells.

The at least one TN cell (e.g., according to the first method aspect) may be a source cell of the mobility. Alternatively or in addition, the at least one TN node may be a source node of the mobility. Alternatively or in addition, the at least one NTN cell may be a target cell of the mobility. Alternatively or in addition, the at least one NTN node may be a target node of the mobility.

The method (e.g., according to the first method aspect) may further comprise or initiate at least one of measuring a radio signal strength (RSS) of the at least one NTN node or the at least one NTN cell and reporting the measured RSS upon request in the control message; pointing a directional antenna of the radio device to the at least one NTN node according to the control message or applying a precoder to a plurality of antennas of the radio device for pointing a radio beam to the at least one NTN node according to the control message; establishing or resuming a connection with the at least one NTN node or the at least one NTN cell according to the control message; transmitting a random access preamble from the radio device to the at least one NTN node or the at least one NTN cell according to the control message; and performing a handover of the radio device from the at least one TN node or the at least one TN cell to the at least one NTN node or the at least one NTN cell according to the control message.

The RSS of the at least one NTN node or NTN cell may be measured and/or the measured RSS may be reported only upon request in the control message. Alternatively or in addition, the radio device may refrain from measuring the RSS of the at least one NTN node or NTN cell and/or may refrain from reporting the measured RSS if an RSS of the TN (e.g., of the at least one TN node or TN cell) is equal to or greater than a predefined TN threshold, e.g., if the RSS of the TN is adequate or sufficient for the connection between the radio device and the at least one TN node or TN cell.

Herein, RSS may be or comprise at least one of a reference signal received power (RSRP), a reference signal received quality (RSRQ), a signal-to-noise ratio (SNR), a signal-to-interference ratio (SIR), a signal-to-interference and noise ratio (SINR). Alternatively or in addition, measuring the RSS of the at least one NTN node or NTN cell may be based on at least one of a reference signal (RS) or a synchronization signal (e.g., a synchronization signal block, SSB, i.e., a synchronization and physical broadcast channel, PBCH, block) of the at least one NTN node or NTN cell.

The plurality of antennas may be referred to as an antenna system, e.g., a multiple-input multiple-output (MIMO) antenna system. Pointing the directional antenna may comprise rotating the directional antenna, e.g., so that a maximum of a radiation characteristic of the directional antenna is directed to the at least one NTN node. Alternatively or in addition, pointing the radio beam may comprise pointing a beamformed transmission (i.e., pointing a maximum of a transmit gain) and/or pointing a beamformed reception (i.e., pointing a maximum of a receive gain), e.g., to the at least one NTN node. The precoder may comprise a beamforming weight (e.g., a complex number) for each of the plurality of antennas.

The connection may be established or resumed upon leaving a coverage area of the TN and/or entering a coverage area of the NTN.

Establishing or resuming the connection may comprise transmitting the random access preamble.

The radio device (e.g., according to the first method aspect) may perform at least one of the steps of claim 7 upon fulfilment of a condition. Alternatively or in addition, the control message may be indicative of the condition. The condition may comprise at least one of leaving the coverage area of the at least one TN node; leaving the at least one TN cell; entering the coverage area of the at least one NTN node; entering the at least one NTN cell; measuring an RSS of the at least one TN node or the at least one TN cell that is equal to or less than a predefined TN RSS threshold; measuring an or the RSS of the at least one NTN node or the at least one NTN cell that is equal to or greater than a predefined RSS NTN threshold; and measuring an or the RSS of the at least one NTN node or the at least one NTN cell that is greater than an RSS of the at least one TN node or the at least one TN cell, optionally by a predefined hysteresis offset.

The fulfilment of the condition may also be referred to as a trigger. Alternatively or in addition, the condition may be a predefined condition for the mobility (e.g., the handover), e.g., from the TN to the NTN or from the NTN to the TN.

Herein, “predefined” may comprise “configured” (e.g., by the control message or a separate configuration message, optionally from the at least one TN node) and/or “specified” (e.g., in a technical specification and/or hard-coded).

The control message (e.g., according to the first method aspect) may be broadcasted, optionally in system information (SI) of the at least one TN node or the at least one TN cell. Alternatively or in addition, the control message may be unicasted to the radio device, optionally in radio resource control (RRC) signaling of the at least one TN node or the at least one TN cell.

The method (e.g., according to the first method aspect) may further comprise or initiate receiving SI from the at least one TN node. The SI may be indicative of supporting the mobility of the radio device between the TN and the NTN and/or the availability of information as to the NTN. The method may further comprise or initiate transmitting a request based on the indication in the SI to the at least one TN node. The control message may be received in response to the transmitted request.

The method (e.g., according to the first method aspect) may further comprise or initiate searching for an NTN cell of the NTN for a predefined time period; and if no NTN cell of the NTN is found during the predefined time period, transmitting a request to the at least one TN node. The control message may be received in response to the transmitted request.

The at least one TN node of the TN (e.g., according to the first method aspect) may provide radio access in the at least one TN cell. Alternatively or in addition, the at least one NTN node of the NTN may provide radio access in at least one NTN cell. The control message may be indicative of at least one of a location of one or each of the at least one TN node; a coverage area covered by one or each of the at least one TN node, optionally at least one of a reference point of the coverage area, a center of the coverage area, and a size of the coverage area; a coverage area covered by one or each of the at least one TN cell, optionally at least one of a reference point of the coverage area, a center of the coverage area, and a size of the coverage area; a cell identifier (cell ID) and/or a carrier frequency of one or each of the at least one TN node or one or each of the at least one TN cell; a handover command for a handover of the radio device from the at least one NTN node or the at least one NTN cell to the at least one TN node or the at least one TN cell; a handover command for a handover of the radio device from the at least one TN node or the at least one TN cell to the at least one NTN node or the at least one NTN cell; a position of the radio device, optionally relative to the at least one TN node; an elevation angle and/or azimuth angle for an uplink transmission from the radio device to the at least one TN node and/or a downlink reception from the at least one TN node at the radio device; a timing advance (TA) or a pre-compensation of the TA, for an uplink transmission from the radio device to the at least one TN node; and a precoder for a beamformed transmission from the radio device to the at least one TN node.

The at least one NTN cell (e.g., according to the first method aspect) may be serving the radio device. Alternatively or in addition, the at least one NTN node may be a serving node of the radio device. Alternatively or in addition, the at least one TN node and the at least one NTN node are neighboring nodes, optionally next-neighboring nodes.

The at least one TN cell (e.g., according to the first method aspect) may be a target cell of the mobility. Alternatively or in addition, the at least one TN node may be a target node of the mobility. Alternatively or in addition, the at least one NTN cell may be a source cell of the mobility. Alternatively or in addition, the at least one NTN node may be a source node of the mobility.

The method (e.g., according to the first method aspect) may further comprise or initiate at least one of measuring a radio signal strength (RSS) of the at least one TN node or the at least one TN cell and reporting the measured RSS upon request in the control message; pointing a directional antenna of the radio device to the at least one TN node according to the control message or applying a precoder to a plurality of antennas of the radio device for pointing a radio beam to the at least one TN node according to the control message; establishing or resuming a connection with the at least one TN node or the at least one TN cell according to the control message; transmitting a random access preamble from the radio device to the at least one TN node or the at least one TN cell according to the control message; and performing a handover of the radio device from the at least one NTN node or the at least one NTN cell to the at least one TN node or the at least one TN cell according to the control message.

The radio device (e.g., according to the first method aspect) may perform at least one of the steps of claim 15 upon fulfilment of a condition. Alternatively or in addition, the control message may be indicative of the condition and/or the condition comprises at least one of leaving the coverage area of the at least one NTN node; leaving the at least one NTN cell; entering the coverage area of the at least one TN node; entering the at least one TN cell; measuring an RSS of the at least one NTN node or the at least one NTN cell that is equal to or less than a predefined NTN RSS threshold; measuring an or the RSS of the at least one TN node or the at least one TN cell that is equal to or greater than a predefined RSS TN threshold; and measuring an or the RSS of the at least one TN node or the at least one TN cell that is greater than an RSS of the at least one NTN node or the at least one NTN cell, optionally by a predefined hysteresis offset.

The control message (e.g., according to the first method aspect) may be broadcasted, optionally in system information (SI) of the at least one TN node or the at least one TN cell. Alternatively or in addition, the control message may be unicasted to the radio device, optionally in radio resource control (RRC) signaling of the at least one TN node or the at least one TN cell.

The method (e.g., according to the first method aspect) may further comprise or initiate receiving SI from the at least one NTN node, the SI being indicative of supporting the mobility of the radio device between the TN and the NTN and/or the availability of information as to the TN. The method may further comprise or initiate transmitting a request based on the indication in the SI to the at least one NTN node. The control message may be received in response to the transmitted request.

The method (e.g., according to the first method aspect) may further comprise or initiate searching for a TN cell of the TN for a predefined time period. If no TN cell of the TN is found during the predefined time period, transmitting a request to the at least one NTN node. The control message may be received in response to the transmitted request.

As to a second method aspect, a method of supporting mobility of a radio device between a terrestrial network (TN) and a non-terrestrial network (NTN) according to claim 20 is provided. The method is performed by at least one TN node of the TN. The method comprises or initiates a step of transmitting a control message from the at least one TN node to the radio device, the control message being indicative of at least one NTN cell of the NTN for supporting the mobility of the radio device between the TN and the NTN.

The second method aspect may be performed by the at least TN node of the TN.

The second method aspect may further comprise any feature and/or any step disclosed in the context of the first method aspect, or a feature and/or step corresponding thereto, e.g., a receiver counterpart or TN counterpart to a transmitter or radio device feature or step.

As to a third method aspect, a method of supporting mobility of a radio device between a terrestrial network (TN) and a non-terrestrial network (NTN) according to claim 22 is provided. The method is performed by at least one NTN node of the NTN. The method comprises or initiates a step of transmitting a control message from the at least one NTN node to the radio device, the control message being indicative of at least one TN cell of the TN for supporting the mobility of the radio device between the TN and the NTN.

The third method aspect may be performed by the at least one NTN node of the NTN.

The third method aspect may further comprise any feature and/or any step disclosed in the context of the first and/or second method aspect, or a feature and/or step corresponding thereto, e.g., a receiver counterpart or NTN counterpart to a transmitter or radio device feature or step.

As to another aspect, a computer program product is provided. The computer program product comprises program code portions for performing any one of the steps of the first and/or second and/or third method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a radio device for supporting mobility of the radio device between a terrestrial network (TN) and a non-terrestrial network (NTN) is provided. The radio device comprises memory operable to store instructions and processing circuitry operable to execute the instructions, such that the radio device is operable to receive at least one of a control message from at least one TN node of the TN at the radio device, the control message being indicative of at least one NTN cell of the NTN for supporting the mobility of the radio device between the TN and the NTN, and a control message from at least one NTN node of the NTN at the radio device, the control message being indicative of at least one TN cell of the TN for supporting the mobility of the radio device between the TN and the NTN.

The radio device (e.g., according to the first device aspect) may be further operable to perform any one of the steps of the first method aspect.

As to another first device aspect a radio device for supporting mobility of the radio device between a terrestrial network (TN), and a non-terrestrial network (NTN) is provided. The radio device is configured to receive at least one of a control message from at least one TN node of the TN at the radio device, the control message being indicative of at least one NTN cell of the NTN for supporting the mobility of the radio device between the TN and the NTN, and a control message from at least one NTN node of the NTN at the radio device, the control message being indicative of at least one TN cell of the TN for supporting the mobility of the radio device between the TN and the NTN.

The radio device (e.g., according to the first device aspect) may further be configured to perform any one of the steps of the first method aspect.

As to another first device aspect a user equipment (UE), for supporting mobility of the UE between a terrestrial network (TN), and a non-terrestrial network (NTN) is provided. The UE being configured to communicate with both a TN node of the TN and an NTN node of the NTN, the UE comprising a radio interface and processing circuitry configured to receive at least one of a control message from at least one TN node of the TN at the radio device, the control message being indicative of at least one NTN cell of the NTN for supporting the mobility of the radio device between the TN and the NTN, and a control message from at least one NTN node of the NTN at the radio device, the control message being indicative of at least one TN cell of the TN for supporting the mobility of the radio device between the TN and the NTN.

The UE (e.g., according to the first device aspect) wherein the processing circuitry may be further configured to execute any one of the steps of the first method aspect.

As to a second device aspect a terrestrial network node (TN) node, for supporting mobility of a radio device between a terrestrial network (TN), and a non-terrestrial network (NTN) is provided. The TN node comprising memory operable to store instructions and processing circuitry operable to execute the instructions, such that the TN node is operable to transmit a control message from the TN node to the radio device, the control message being indicative of at least one NTN cell of the NTN for supporting the mobility of the radio device between the TN and the NTN.

The TN node (e.g., according to the second device aspect) may further be operable to perform any one of the steps of the second method aspect.

As to another second device aspect a terrestrial network node (TN) node), for supporting mobility of a radio device between a terrestrial network (TN), and a non-terrestrial network (NTN) is provided. The TN node being configured to transmit a control message from the TN node to the radio device, the control message being indicative of at least one NTN cell of the NTN for supporting the mobility of the radio device between the TN and the NTN.

The TN node (e.g., according to the second device aspect) may further configured to perform any one of the steps of the second method aspect.

As to a third device aspect a non-terrestrial network node (NTN) node, for supporting mobility of a radio device between a terrestrial network (TN), and a non-terrestrial network (NTN) is provided. The NTN node comprising memory operable to store instructions and processing circuitry operable to execute the instructions, such that the NTN node is operable to transmit a control message from the at least one NTN node to the radio device, the control message being indicative of at least one TN cell of the TN for supporting the mobility of the radio device between the TN and the NTN.

The NTN node (e.g., according to the third device aspect) may further be operable to perform any one of the steps of the third method aspect.

As to another third device aspect a non-terrestrial network node (NTN) node, for supporting mobility of a radio device between a terrestrial network (TN), and a non-terrestrial network (NTN) is provided. The NTN node is configured to transmit a control message from the at least one NTN node to the radio device, the control message being indicative of at least one TN cell of the TN for supporting the mobility of the radio device between the TN and the NTN.

The NTN node (e.g., according to the third device aspect) may further be configured to perform any one of the steps of the third method aspect.

As to a system aspect a communication system is provided. The communication system includes a host computer comprising processing circuitry configured to provide user data and a communication interface configured to forward user data to a terrestrial network (TN) or a non-terrestrial network for transmission to a user equipment (UE). The UE comprises a radio interface and processing circuitry, wherein the processing circuitry of the UE is configured to execute any one of the steps of the first method aspect.

The communication system (e.g., according to the system aspect) may further including the UE.

The TN and the NTN (e.g., according to the system aspect) may further comprise a TN node and an NTN node, each of which is configured to communicate with the UE.

Each of the TN and the NTN (e.g., according to the system aspect) may comprise processing circuitry, which is configured to execute any one of the steps of the second method aspect and the third method aspect, respectively.

The processing circuitry of the host computer (e.g., according to the system aspect) may be configured to execute a host application, thereby providing the user data. The processing circuitry of the UE may be configured to execute a client application associated with the host application.

Without limitation, for example in a 3GPP implementation, any “radio device” may be a user equipment (UE). Any one of the method aspects may be embodied by a method for supporting terrestrial to non-terrestrial network service continuity.

Embodiments of the technique may be implemented for at least one of 5G NR, NB-IoT, LTE-M, NTN, satellite communication, and service continuity.

The technique may be applied in the context of 3GPP New Radio (NR), e.g., in fulfilment of one or more Quality of Service (Qos) levels.

The technique may be implemented in accordance with a 3GPP specification, e.g., for 3GPP release 17 or 18. The technique may be implemented for 3GPP LTE or 3GPP NR, e.g., according to a modification of the 3GPP document TS 38.331, version 16.6.0. For example, the control message may be implemented using or modifying radio resource control (RRC) signaling specified in the 3GPP document TS 38.331 for NR.

The radio device may receive multiple instances of the control message. For example, a first instance of the control message may comprise an indicative of support for the at least one TN node signaling NTN information to the radio device (e.g., upon request) in a second instance of the control message. Alternatively or in addition, different instances of the control message may be received from different TN nodes (of the at least one TN node) or from different NTN nodes (of the at least one NTN node) or from the at least one TN node and the at least one NTN node.

The radio device may be a user equipment (UE), e.g., according to a 3GPP specification. Alternatively or in addition, the at least one NTN node may be a satellite or spaceborne base station. Alternatively or in addition, the TN node may be a stationary and/or terrestrial (e.g., ground-base) base station.

For serving the radio device, the radio device may be wirelessly connected to the at least one TN node and/or the at least one NTN in an uplink (UL) and/or a downlink (DL) through a Uu interface. Alternatively or in addition, the wireless connection between the at least one NTN node and the radio device may use Ku- and Ka-microwave bands, which operate in the 12-18 GHz and 26.5-49 GHz bands respectively.

The RAN, i.e., the TN and the NTN, may comprise one or more base stations performing the second and third method aspect, respectively.

Any of the radio devices may be a 3GPP user equipment (UE) or a Wi-Fi station (STA) or a Subscriber Ground Station. The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the TN, and/or the NTN, it may be implemented by one or more base stations acting as the TN and NTN nodes.

Herein, being wirelessly connected or establishing a connection or resuming a connection or serving the radio device may be refer to the radio device being connected according to a radio resource control (RRC) state or active mode, optionally with at least one base station of the RAN.

A base station (i.e., any NT node and/or any NTN node) may encompass any station that is configured to provide radio access to one or more embodiments of the radio device. A base station (i.e., any NT node and/or any NTN node) may also be referred to as cell, transmission and reception point (TRP), radio access node or access point (AP). The base station and/or the radio device may provide a data link to a host computer providing user data to the radio device or gathering user data from the radio device. Examples for the base stations (i.e., any NT node and/or any NTN node) may include a 3G base station or Node B (NB), 4G base station or eNodeB (eNB), a 5G base station or gNodeB (gNB), a Wi-Fi AP and a network controller (e.g., according to Bluetooth, ZigBee or Z-Wave).

The RAN (e.g., the TN and/or the NTN) may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

In any aspect, the control message may comprise different types of TN signaling for preparing the radio device (e.g., a UE) to make an efficient transfer from TN connectivity to NTN connectivity and/or from NTN connectivity to TN connectivity.

Alternatively or in addition, in any aspect, the control message may comprise 3GPP TN signaling of 3GPP NTN information that aids the mobility (e.g., a handover) from TN connectivity to NTN connectivity and/or from NTN connectivity to TN connectivity.

The at least one TN node may be a or one TN node. The at least one NTN node may be a or one NTN node.

As to a still further aspect a communication system including a host computer is provided. The host computer comprises a processing circuitry configured to provide user data. The host computer further comprises a communication interface configured to forward the data to a cellular network (e.g., the RAN, the TN, the NTN, any of the base stations, the at least one TN node, and/or the at least one NTN node) for transmission to a UE. A processing circuitry of the cellular network is configured to execute any one of the steps of the second and/or third method aspect. The UE comprises a radio interface and processing circuitry, which is configured to execute any one of the steps of the first method aspect.

The communication system may further include the UE. Alternatively, or in addition, the cellular network may further include one or more base stations configured for radio communication with the UE and/or to provide a data link between the UE and the host computer using the first and/or second and/or third method aspects.

The processing circuitry of the host computer may be configured to execute a host application, thereby providing the data and/or any host computer functionality described herein. Alternatively, or in addition, the processing circuitry of the UE may be configured to execute a client application associated with the host application.

Any one of the devices, the radio device, the UE, any of the base stations, the TN node, the NTN node, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for supporting mobility of a radio device between a TN and an NTN, which may be implementable at the radio device;

FIG. 2 shows a schematic block diagram of an embodiment of a device for supporting mobility of a radio device between a TN and an NTN, which may be implementable at the TN;

FIG. 2′ shows a schematic block diagram of an embodiment of a device for supporting mobility of a radio device between a TN and an NTN, which may be implementable at the NTN;

FIG. 3 shows a flowchart for a method of supporting mobility of a radio device between a TN and an NTN, which method may be implementable by the device of FIG. 1;

FIG. 4 shows a flowchart for a method of supporting mobility of a radio device between a TN and an NTN, which method may be implementable by the device of FIG. 2;

FIG. 4′ shows a flowchart for a method of supporting mobility of a radio device between a TN and an NTN, which method may be implementable by the device of FIG. 3;

FIG. 5 schematically illustrates an example of an NTN comprising embodiments of the devices of FIGS. 1, 2, and 2′ for performing the methods of FIGS. 3, 4, and 4′, respectively;

FIG. 6A schematically illustrates an example of a RAN comprising embodiments of the devices of FIGS. 1 and 2 for performing the methods of FIGS. 3 and 4, respectively;

FIG. 6B schematically illustrates a signaling diagram resulting from embodiments of the devices of FIGS. 1 and 2 performing the methods of FIGS. 3 and 4, respectively, in radio communication;

FIG. 7A schematically illustrates an example of a RAN comprising embodiments of the devices of FIGS. 1 and 2′ for performing the methods of FIGS. 3 and 4′, respectively;

FIG. 7B schematically illustrates a signaling diagram resulting from embodiments of the devices of FIGS. 1 and 2′ performing the methods of FIGS. 3 and 4′, respectively, in radio communication;

FIG. 8 shows a schematic block diagram of a radio device embodying the device of FIG. 1;

FIG. 9 shows a schematic block diagram of a TN node embodying the device of FIG. 2;

FIG. 9′ shows a schematic block diagram of an NTN node embodying the device of FIG. 2′;

FIG. 10 schematically illustrates an example telecommunication network connected via an intermediate network to a host computer;

FIG. 11 shows a generalized block diagram of a host computer communicating via a base station or radio device functioning as a gateway with a user equipment over a partially wireless connection; and

FIGS. 12 and 13 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

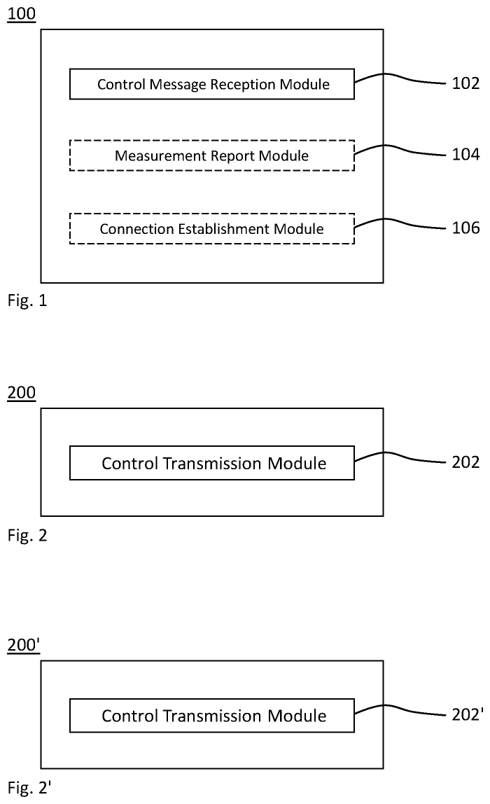

FIG. 1 schematically illustrates a block diagram of an embodiment of a device for supporting mobility of a radio device between a terrestrial network (TN) and a non-terrestrial network (NTN) and/or according to the first device aspect. The device is generically referred to by reference sign 100.

The device 100 comprises a control message reception module 102 that receives at least one control message.

At least one control message may be received from at least one (e.g., a) TN node of the TN at the radio device. Latter control message may be indicative of at least one NTN cell of the NTN for supporting the mobility of the radio device between the TN and the NTN, e.g., from the TN the NTN.

Alternatively or in addition, at least one control message may be received from at least one (e.g., a) NTN node of the NTN at the radio device. The latter control message may be indicative of at least one TN cell of the TN for supporting the mobility of the radio device between the TN and the NTN, e.g., from the NTN to the TN.

Optionally, the device 100 comprises a measurement report module 104 that measures a radio signal strength (RSS) of the at least one NTN node and/or the at least one NTN cell, and/or that reports the measured RSS to the TN or the NTN, e.g., upon request in the control message.

Alternatively or in addition, the device 100 comprises a connection establishment module that establishes or resumes a connection with the at least one NTN node and/or the at least one NTN cell and/or the at least one TN node and/or the at least one TN cell according to the control message.

Any of the modules of the device 100 may be implemented by units configured to provide the corresponding functionality.

The device 100 may also be referred to as, or may be embodied by, the radio device (or briefly: UE).

The radio device 100 and the at least one TN node may be in direct radio communication, e.g., at least when receiving the control message and prior to the establishing or resuming of the connection. The radio device 100 and the at least one NTN node may be in direct radio communication, e.g., as a result or after the establishing or resuming of the connection.

Alternatively or in addition, the radio device 100 and the at least one NTN node may be in direct radio communication, e.g., at least when receiving the control message and prior to the establishing or resuming of the connection. The radio device 100 and the at least one TN node may be in direct radio communication, e.g., as a result or after the establishing or resuming of the connection.

The at least one TN node may be embodied by below device 200. The at least one NTN node may be embodied by further below device 200′.

FIG. 2 schematically illustrates a block diagram of an embodiment of a device for supporting mobility of a radio device between a terrestrial network (TN) and a non-terrestrial network (NTN) and/or according to the second device aspect. The device is generically referred to by reference sign 200.

The device 200 comprises a control transmission module 202 that transmits a control message, e.g., as described in the context of the first and/or second (e.g., method or device) aspect.

Any of the modules of the device 200 may be implemented by units configured to provide the corresponding functionality.

The device 200 may also be referred to as, or may be embodied by, the TN node (or briefly: gNB).

FIG. 2′ schematically illustrates a block diagram of an embodiment of a device for supporting mobility of a radio device between a terrestrial network (TN) and a non-terrestrial network (NTN) and/or according to the third device aspect. The device is generically referred to by reference sign 200′.

The device 200′ comprises a control transmission module 202′ that transmits a control message, e.g., as described in the context of the first and/or third (e.g., method or device) aspect.

Any of the modules of the device 200 may be implemented by units configured to provide the corresponding functionality.

The device 200′ may also be referred to as, or may be embodied by, the NTN node (or briefly: satellite or HAP).

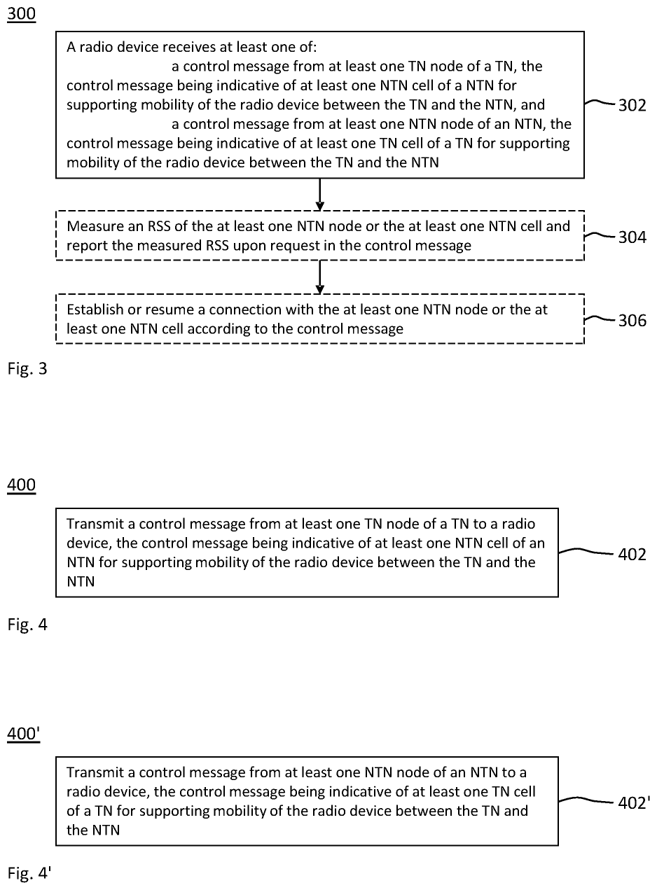

FIG. 3 shows an example flowchart for a method 300 of performing an embodiment of the first method aspect.

In a step 302, a radio device receives at least one of
a control message from at least one TN node of the TN at the radio device, the control message being indicative of at least one NTN cell of the NTN for supporting the mobility of the radio device between the TN and the NTN, and
a control message from at least one NTN node of the NTN at the radio device, the control message being indicative of at least one TN cell of the TN for supporting the mobility of the radio device between the TN and the NTN.

The method 300 may be performed by the device 100. For example, the modules 102, 104, and 106 may perform the steps 302, 304, and 306, respectively.

FIG. 4 shows an example flowchart for a method 400 of performing an embodiment of the second method aspect.

In a step 402, a or at least one TN node transmits a control message to the radio device. The control message is indicative of at least one NTN cell of the NTN for supporting the mobility of the radio device between the TN and the NTN.

The method 400 may be performed by the device 200. For example, the modules 202 may perform the step 402.

FIG. 4′ shows an example flowchart for a method 400′ of performing an embodiment of the third method aspect.

In a step 402′, a or at least one NTN node transmits a control message to the radio device. The control message is indicative of at least one TN cell of the TN for supporting the mobility of the radio device between the TN and the NTN.

The method 400′ may be performed by the device 200′. For example, the modules 202 may perform the step 402.

In any aspect, the device 100 may be a radio device. The TN node 200 may be a terrestrial base station. The NTN node 200′ may be a non-terrestrial base station (e.g., a satellite or a HAP).

Herein, any radio device may be a mobile or portable station and/or any radio device wirelessly connectable to a base station or RAN (e.g., the TN and/or the NTN). For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR).

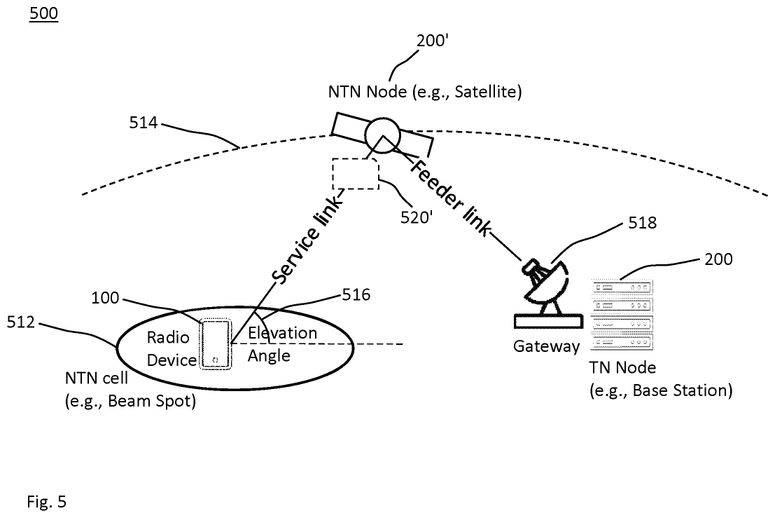

FIG. 5 shows an example architecture of a satellite network with bent pipe transponders as an embodiment of the NTN 500. The depicted elevation angle 516 of the service link is important as it impacts the distance between the satellite as an embodiment of the NTN node 200′ and the radio device 100, and the velocity of the satellite 200′ relative to the radio device 100.

The NTN 500 (e.g., according to 3GPP) may comprise at least one of satellite communication and communications using high-altitude platforms (HAPs) as examples of the NTN nodes 200′. In this section we focus on satellite communication, but the provided description is readily applied to at least one HAPs 200′ and a HAP network as the NTN 500.

A satellite radio access network as the NTN 500 may comprise at least one of the following components:
at least one satellite as the at least one NTN node 200′, which may also be referred to as a space-borne platform;
an earth-based gateway 518 that connects the satellite 200′ to a base station 200 and/or a core network, e.g., depending on the choice of architecture;
a feeder link, i.e., a radio link between the gateway 518 and the satellite 200′; and
an access link, i.e., a radio link between the satellite 200′ and the radio device 100.

Depending on an orbit altitude (i.e., height), the satellite 200′ may be categorized as low earth orbit (LEO), medium earth orbit (MEO), or geostationary earth orbit (GEO) satellite. LEO may comprise heights ranging from 250 km to 1,500 km, e.g., with orbital periods ranging from 90 minutes to 120 minutes. MEO may comprise heights ranging from 5,000 km to 25,000 km, e.g., with orbital periods ranging from 3 hours to 15 hours. GEO may comprise a height at about 35,786 km and/or an orbital period of 24 hours.

A communication satellite typically generates several beams over a given area (i.e., the coverage area). The footprint of a beam is usually in an elliptic shape, which may be considered as a TN cell 512. The footprint of a beam may also be referred to as a beam spot (also: spotbeam). The footprint of a beam may move over the earth surface with the satellite movement or may be earth-fixed with some beam pointing mechanism used by the satellite to compensate for its motion. A size 524 of a beam spot depends on the system design, which may range from tens of kilometers to a few thousands of kilometers.

FIG. 5 schematically illustrates an example architecture of an embodiment of the NTN 500 comprising a satellite network, optionally with bent pipe transponders.

The satellite orbit is determined based on ephemeris data. 3GPP has agreed that ephemeris data of a serving satellite 200′ should be provided to the radio device 100 (e.g., UE), for example to assist with pointing a directional antenna (or an antenna beam) towards the satellite 200′. Alternatively or in addition, the radio device 100 knowing its own position (e.g. based on a global navigation satellite system, GNSS) may use the ephemeris data to calculate and/or correct a Timing Advance (TA) and/or a Doppler shift used when establishing a link to the satellite (e.g., when transmitting a random access preamble or performing a random access procedure).

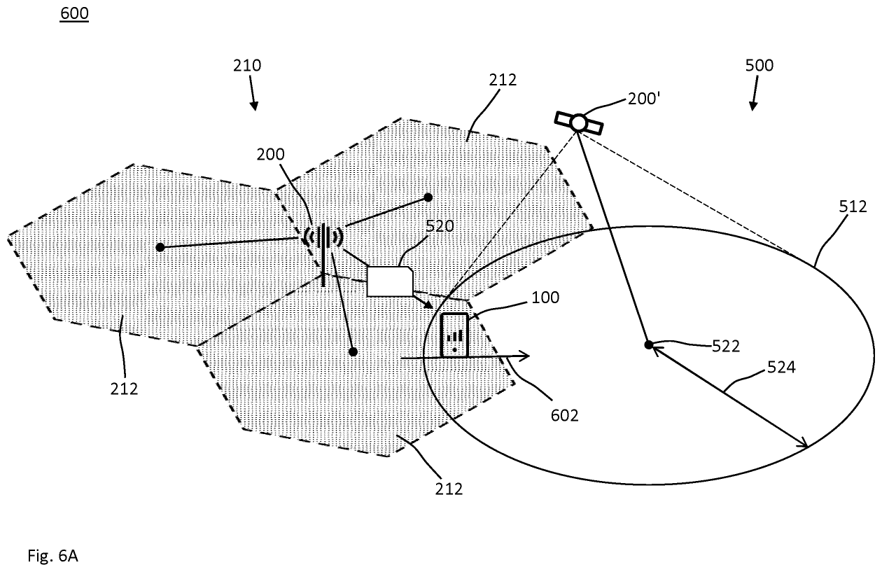

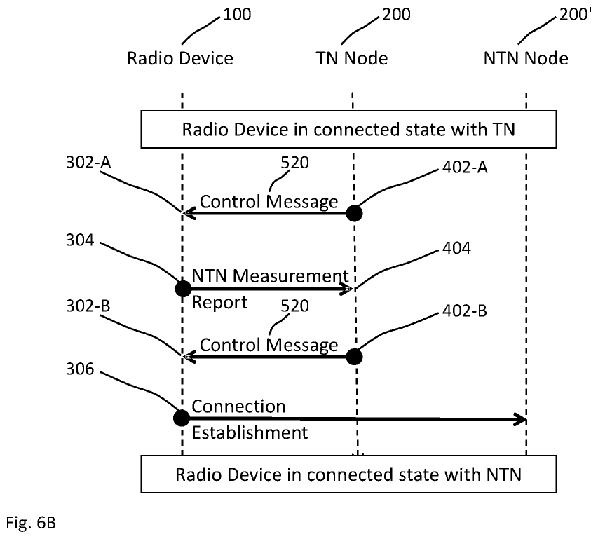

In any aspect, an example includes a scenario in which the radio device 100 (e.g., a UE) needs to be handed over to the NTN 500 when the radio device 100 is leaving coverage of the TN 210 (i.e., a coverage area of the TN and/or a TN cell of the TN), e.g., as illustrated in FIG. 6A.

Before the radio device 100 (e.g., a UE) can establish and/or resume the connection to a target cell 512 in the NTN 500 (i.e., an NTN cell 512 of the NTN 500), the radio device 100 may need to determine a position of the satellite 200′ the NTN coverage (i.e., a satellite 200′ embodying the NTN node) and/or its own position. For example, the radio device may determine, based on the control message 520, a timing advance (TA) pre-compensation prior to triggering a random access (RA) procedure (e.g., for transmitting a RA preamble) to the target cell 512. Without the control message 520, this would be a time-consuming task that deteriorates the experienced end user performance, e.g., if the radio device 100 is connecting to the NTN 500 for a first time after powering-on the radio device 100.

In any aspect, another example includes a scenario in which the radio device 100 (e.g., a UE) performs radio resource management (RRM) measurements 304 on a (e.g., neighboring) NTN (briefly: NTN measurements), e.g., on the at least one NTN cell 512 neighboring the at least one TN cell 212 serving the radio device 100. Such RRM measurements 304 are power consuming. For the radio device 100 (e.g., a UE) experiencing coverage by both the TN 210 and the NTN 500, it may be wasteful to perform such NTN measurements if the TN signal strength is adequate. Embodiments of the technique may limit and/or control the NTN measurements according to the control message 520.

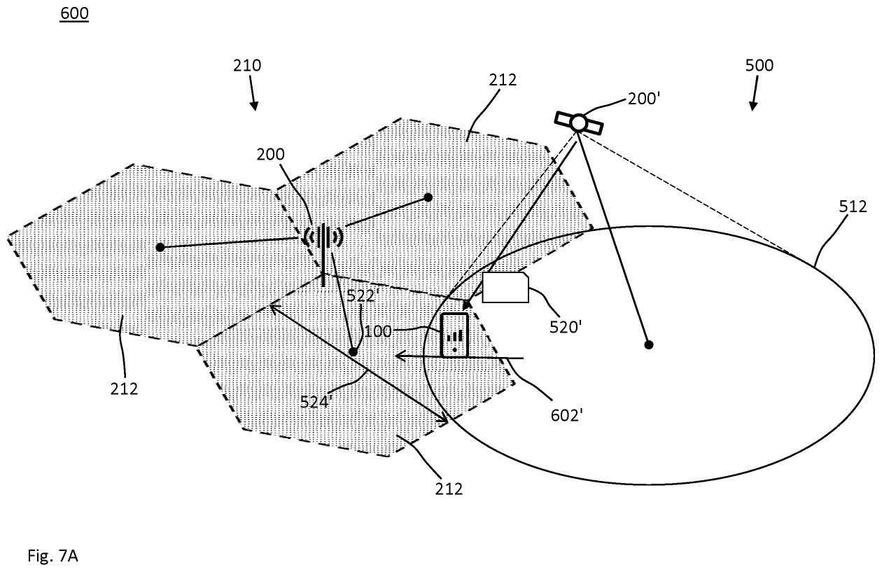

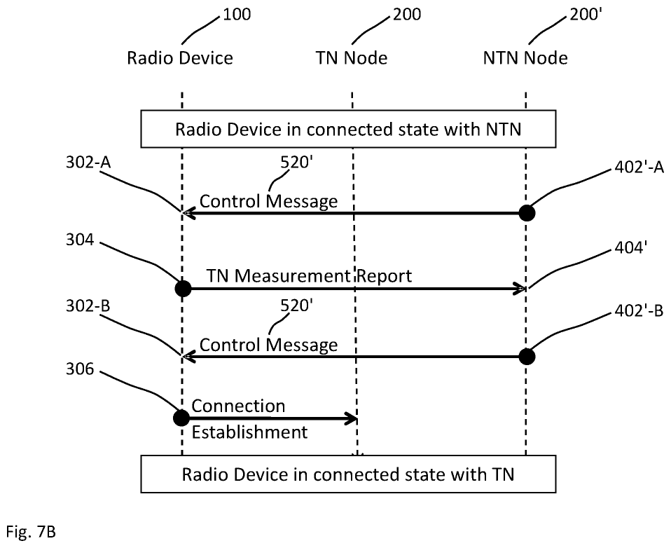

FIG. 6A and FIG. 7A schematically illustrate an embodiment of a radio device (e.g., a UE) that moves from coverage of an embodiment of a TN 210 to coverage of an embodiment of an NTN 500, and vice versa, respectively.

The TN 210 and the NTN 500 may be segments of a random access network (RAN) 600.

In below detailed embodiments, the radio device 100 is referred to as a UE for brevity and not limitation. Furthermore, any one of the below detailed embodiments may be implemented as such or in combination with any of the above described embodiments and/or any of the embodiments in the list of embodiments.

In a first detailed embodiment, a terrestrial network (TN) node 200 signals information (e.g., in the control message 520) concerning a non-terrestrial network (NTN) to a UE 100. The control message may support a handover of the UE 100 to the NTN 500. The information in the control message 520 comprises assistance information, e.g., ephemeris, of a satellite 200′ providing the NTN coverage. Based on knowing the satellite ephemeris, the UE 100 may point its directional antenna, or antenna beam, toward the satellite 200′ for expediting the handover from the TN 210 to the NTN 500.

In a first implementation of the first detailed embodiment, the information (e.g., the control message 520), e.g., ephemeris, may be provided via system information (SI) broadcast in a source cell (e.g., a TN cell 212) that is a (e.g., next) neighbor cell to the NTN cell 512 in the NTN 500. This means that the information could be acquired by all UEs in the TN cell, e.g., regardless of whether the respective UE is likely for them to be handed over to an NTN cell 512 in the NTN 500. In a variant, the TN cell 212 may broadcast a reference point (e.g., the NTN cell center 522) and/or distance (e.g., a range or diameter 524 or some other expression), which indicates to the UE 100 when to start preparing for measuring and/or for accessing the NTN 500, e.g., by determining and/or following a satellite location (i.e., position) in order to determine a suitable time for a (e.g., initial) transmission of a random access (RA) preamble (RAP).

In a second implementation of the first detailed embodiment, the information (e.g., the control message 520) may be provided as part of a handover command to a UE 100 which is to be handed over to an NTN cell 512 in the NTN 500. In this case, only the UE 100 that is to be handed over to an NTN cell 512 in the NTN 500 receives the information. Currently, it is possible to provide SIB1 and SIB2 as part of the handover command, but if, e.g., ephemeris information of the satellite providing the NTN coverage is specified to be provided in another SIB, that particular SIB is provided as part of the handover command. It is also possible that the information can be provided via an explicit set of field parameters rather than the or a system information block (SIB).

In a third implementation of the first detailed embodiment, the TN 210 broadcasts (e.g., as a first instance of the control message 520), e.g., in SIB, only an indication that NTN-related information is available. The UE 100 may then request the information to be transmitted in a second instance of the control message 520, e.g. via dedicated signaling (e.g., RRC signaling). The background here can be that a UE 100—even though technically NTN-capable-might still not want to be handed over to an NTN, for example because the handover might entail additional costs for a user of the UE 100. In this way, the TN 210 can be able to know which UEs 100 should be handed over to the NTN and which should not.

In a fourth implementation of the first detailed embodiment, when an NTN-capable UE 100 (i.e., an embodiment of the UE 100) is powered on, the UE 100 may first search for a TN cell 212 that signals information concerning an NTN 500 (e.g., the control message 520), and/or decodes the information (e.g., the control message 520) transmitted from the TN cell 512 about the NTN 500, and/or then utilize the assistance information (e.g., the control message 520) to search for an NTN cell. Alternatively, the NTN-capable UE 100 (i.e., an embodiment of the UE 100) may first search for an NTN cell 512 for a period of time. If the UE 100 cannot find an NTN cell 512 after the period of time, the UE 100 may receive the information (e.g., the control message 520) transmitted from a TN cell 512 about the NTN 500, and/or then utilize the assistance information (e.g., the control message 520) to search for an NTN cell 512.

In a fifth implementation of the first detailed embodiment, a UE 100 signals to the network that it is capable of TN-NTN dual connectivity (DC). The UE 100 (e.g., in response to the signaling of the capable of TN-NTN DC) is configured (e.g., by the TN node 200) with a Master cell group that comprises one or more of TN cells 212 (e.g., denoted as TN MCG) and a Secondary cell group that comprises one or more NTN cells 512 (e.g., denoted as NTN SCG). The TN 210 transmits system information (SI) (e.g., as an example of the control message 520) of NTN SCG through signaling in the TN MCG.

FIG. 6B schematically illustrates a signaling diagram for a handover of the UE 100 from the TN 210 to the NTN 500, e.g., according to the first detailed embodiment. The step 302 may comprise a sub-step 302-A of receiving a first instance of the control message 520 (e.g., from TN node 200) that triggers or configures (e.g., conditionally triggers) the UE 100 to start measuring 304 the RSS of the at least one NTN cell 512. Optionally, the measured RSS is reported to the TN node 200. Depending on the measured RSS, e.g., in response to a second instance of the control message 520 received in response to the measurement report, the UE initiates 306 an access procedure for establishing or resuming a connection with the at least one NTN node 200′.

Steps 402-A, 404, and 402-B of the method 400 correspond to the steps 302-A, 304, and 302-B of the method 300.

In second detailed embodiment, which may be implemented alone or in combination with the first detailed embodiment, an NTN node 200′ signals information (e.g., the control message 520′) concerning a TN 210 to a UE 100. FIG. 7A schematically illustrates a RAN 600 comprising embodiments of the TN 210 and the NTN 500 and an embodiment of the UE 100 to be handed over from the NTN 500 to the TN 210.

For example, in the signaling diagram of FIG. 7B, steps 402′-A, 404′, and 402′-B of the method 400′ correspond to the steps 302-A, 304, and 302-B of the method 300.

The control message 520′ is to support a handover (HO) of the UE from NTN 500 to the TN 210. This information, i.e., the control message 520′, comprises assistance information, e.g., the cell ID and/or carrier frequency of the TN cell 212 (e.g., as the target cell). Based on knowing the information about the TN 210 (e.g., the TN cell 212), the UE 100 may start to measure the TN 210 (e.g., the TN cell 212) for preparing the handover from the NTN 500 to the TN 210.

For a UE 100 supporting NTN features, i.e. an embodiment of the UE 100, it may be possible to give or be given in the control command 520 (e.g., by the TN 210) a conditional HO (CHO) command. The CHO command may be a handover command that is subject to a condition. The condition may comprise a location threshold for a location of the UE 100 (e.g., relative to the NTN cell 512 and/or the NTN node 200′) and/or an RSS TN threshold for the RSS of the TN 210 and/or an RSS NTN threshold for the RSS of the NTN and/or a comparison between an RSS of the TN and an RSS of the NTN 500, e.g., for performing the HO.

In another detailed embodiment or a variant of the second detailed embodiment, the TN node 200 may give the UE 100 an enhanced CHO command to the NTN 500 which has a second location threshold which guides UE to when the UE is close to the actual location threshold to perform the HO and thus when to start measuring 304 the NTN cell 512. This can be beneficial as the NTN cell 512 may have a RSRP level coverage that is very wide and the UE 100 may be able to detect and measure the NTN cell 512 well ahead of time when UE 100 is actually supposed to HO to the NTN 500. From system perspective (e.g., the second device aspect), as the TN 210 may have a better capability (e.g., greater data rate compared to the NTN 500) to serve the UE 100, the UE 100 may access the NTN 500 only when TN coverage is not adequate.

In another embodiment or a variant of the first detailed embodiment, a terrestrial network (TN) node 200 signals information (e.g., an instance of the control message 520) that comprises an almanac for a GNSS or any navigation satellite system. The almanac may comprise a coarse orbit and/or status information as to navigation satellites (or satellites 200′) in a constellation, and/or the relevant ionospheric model and/or time-related information of the GNSS or any navigation satellite system, e.g., so that the handover between the TN 210 and the NTN 500 can be performed with better service continuity.

The UE 100 may consider the information (e.g., the control message 520) provided as an implicit indication for turning on an GNSS receiver for the GNSS and/or speeding up a warm-up phase by reducing the time required to acquire, for example, the orbit of the at least one satellite 200′ and/or status information of the navigation satellites in the constellation of the GNSS or any navigation satellite system or the satellites 200′. Another benefit may comprise a reduction of power consumption of the UE 100.

In a first implementation (e.g., of the first and/or second detailed embodiment), such information (e.g., the control message 520 or 520′) may be provided via system information (SI) broadcast in the source cell that is neighbor to the NTN cell 512 (e.g., the target or the serving cell) in the NTN 500. This may mean that the information would be acquired by all UEs 100 in the TN cell 212 or the NTN cell 512 regardless of whether it is likely for them to be handed over to an TN cell 212 in the TN 210 or to an NTN cell 512 in the NTN 500.

In a second implementation (e.g., of the first and/or second detailed embodiment), the information (e.g., the control information 520 or 520′) can be provided as part of the handover command to a UE 100 which is to be handed over to a cell in the TN 210 or in the NTN 500. In this case, only the UE 100 that is to be handed over to a cell in the TN 210 or in the NTN 510 receives the information.

In a third dependent embodiment, the information can be provided to the UE via dedicated signaling considering the possibility of a handover in the near future based on the measurement reports provided by the UE 100 (e.g., in the step 304) so that there is enough time for the UE 100 to turn on a receiver for the navigation system in advance prior to receiving the handover command.

The triggering for providing the information to the UE can be based on, for example, a first time the UE 100 reports after a configured event is fulfilled, or the frequency of reporting, or a threshold with respect to a particular measurement is reached. This may be up to network implementation or a request from the UE 100 may be provided to the TN 210.

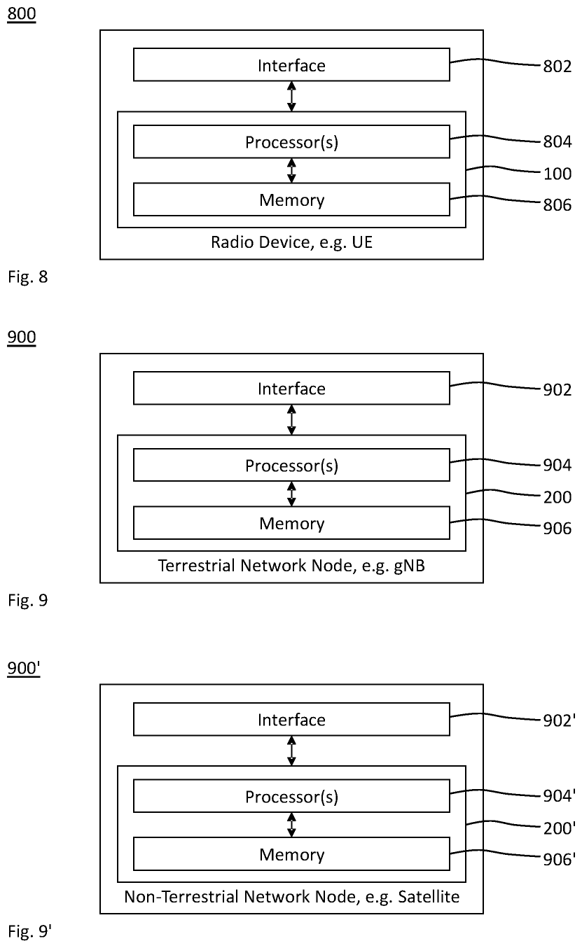

FIG. 8 shows a schematic block diagram for an embodiment of the device 100. The device 100 comprises processing circuitry, e.g., one or more processors 804 for performing the method 300 and memory 806 coupled to the processors 804. For example, the memory 806 may be encoded with instructions that implement at least one of the modules 102, 104 and 106.

The one or more processors 804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 806, transmitter and/or radio device functionality. For example, the one or more processors 804 may execute instructions stored in the memory 806. Such functionality may include providing various features and steps discussed herein, including any of the benefits disclosed herein. The expression “the device being operative to perform an action” may denote the device 100 being configured to perform the action.

As schematically illustrated in FIG. 8, the device 100 may be embodied by a radio device 800, e.g., functioning as a transmitter and/or a UE. The radio device 800 comprises a radio interface 802 coupled to the device 100 for radio communication with one or more network nodes (i.e., base stations), e.g., functioning as a TN node 200 and/or an NTN node 200′.

FIG. 9 shows a schematic block diagram for an embodiment of the device 200. The device 200 comprises processing circuitry, e.g., one or more processors 904 for performing the method 400 and memory 906 coupled to the processors 904. For example, the memory 906 may be encoded with instructions that implement the module 202.

The one or more processors 904 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 906, receiver and/or network node functionality. For example, the one or more processors 904 may execute instructions stored in the memory 906. Such functionality may include providing various features and steps discussed herein, including any of the benefits disclosed herein. The expression “the device being operative to perform an action” may denote the device 200 being configured to perform the action.

As schematically illustrated in FIG. 9, the device 200 may be embodied by a terrestrial network (TN) node 900, e.g., functioning as a receiving base station and/or a gNB. The TN node 900 comprises a radio interface 902 coupled to the device 200 for radio communication with one or more radio devices, e.g., functioning as a UE.

FIG. 9′ shows a schematic block diagram for an embodiment of the device 200′. The device 200′ comprises processing circuitry, e.g., one or more processors 904′ for performing the method 400′ and memory 906′ coupled to the processors 904′. For example, the memory 906′ may be encoded with instructions that implement the module 202′.

The one or more processors 904′ may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200′, such as the memory 906′, receiver and/or network node functionality. For example, the one or more processors 904′ may execute instructions stored in the memory 906′. Such functionality may include providing various features and steps discussed herein, including any of the benefits disclosed herein. The expression “the device being operative to perform an action” may denote the device 200′ being configured to perform the action.

As schematically illustrated in FIG. 9′, the device 200′ may be embodied by a non-terrestrial network (NTN) node 900′, e.g., functioning as a receiving base station and/or a satellite and/or HAP. The NTN node 900′ comprises a radio interface 902′ coupled to the device 200′ for radio communication with one or more radio devices, e.g., functioning as a UE.

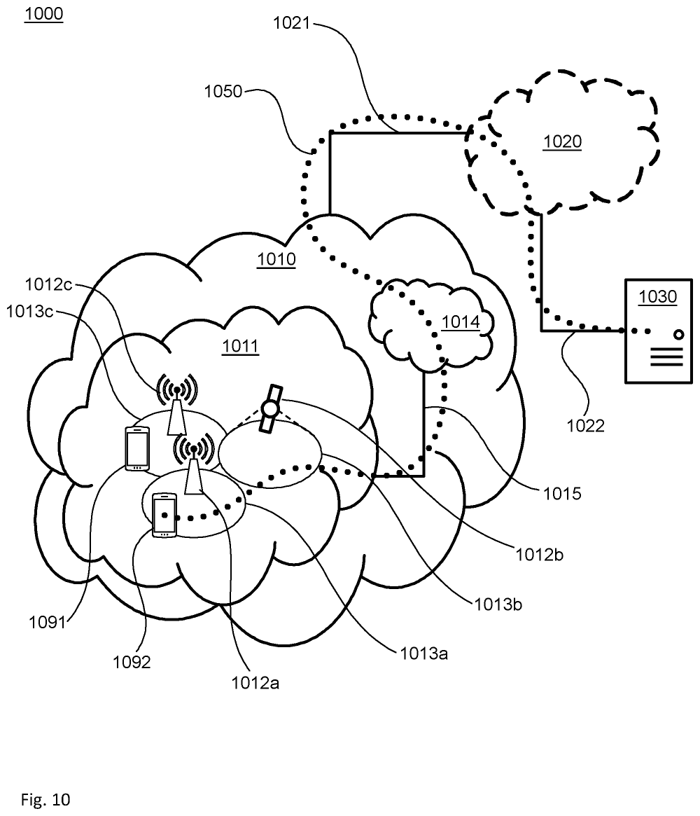

With reference to FIG. 10, in accordance with an embodiment, a communication system 1000 includes a telecommunication network 1010, such as a 3GPP-type cellular network, which comprises an access network 1011, such as a radio access network, and a core network 1014. The access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to the core network 1014 over a wired or wireless connection 1015. A first user equipment (UE) 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

Any of the base stations 1012 and the UEs 1091, 1092 may embody the device 100.

The telecommunication network 1010 is itself connected to a host computer 1030, which may be embodied in the hardware and/or software of a standalone server, a cloud-implemented server, a distributed server or as processing resources in a server farm. The host computer 1030 may be under the ownership or control of a service provider, or may be operated by the service provider or on behalf of the service provider. The connections 1021, 1022 between the telecommunication network 1010 and the host computer 1030 may extend directly from the core network 1014 to the host computer 1030 or may go via an optional intermediate network 1020. The intermediate network 1020 may be one of, or a combination of more than one of, a public, private or hosted network; the intermediate network 1020, if any, may be a backbone network or the Internet; in particular, the intermediate network 1020 may comprise two or more sub-networks (not shown).

The communication system 1000 of FIG. 10 as a whole enables connectivity between one of the connected UEs 1091, 1092 and the host computer 1030. The connectivity may be described as an over-the-top (OTT) connection 1050. The host computer 1030 and the connected UEs 1091, 1092 are configured to communicate data and/or signaling via the OTT connection 1050, using the access network 1011, the core network 1014, any intermediate network 1020 and possible further infrastructure (not shown) as intermediaries. The OTT connection 1050 may be transparent in the sense that the participating communication devices through which the OTT connection 1050 passes are unaware of routing of uplink and downlink communications. For example, a base station 1012 need not be informed about the past routing of an incoming downlink communication with data originating from a host computer 1030 to be forwarded (e.g., handed over) to a connected UE 1091. Similarly, the base station 1012 need not be aware of the future routing of an outgoing uplink communication originating from the UE 1091 towards the host computer 1030.

By virtue of the method 300 being performed by any one of the UEs 1091 or 1092 as the radio device 100 and/or the method 400 being performed by any one of the base stations 1012a and 1012c as TN node 200 and/or the method 400′ being performed by the base station 1012b as NTN node 200′, the performance or range of the OTT connection 1050 can be improved, e.g., in terms of increased throughput and/or reduced latency. More specifically, the host computer 1030 may indicate to the RAN 600 or the TN 210 or the NTN 500 or the TN node 200 or the NTN node 200′, or the radio device 100 (e.g., on an application layer) a QoS of the traffic or any other explicit or implicit trigger for performing the technique.

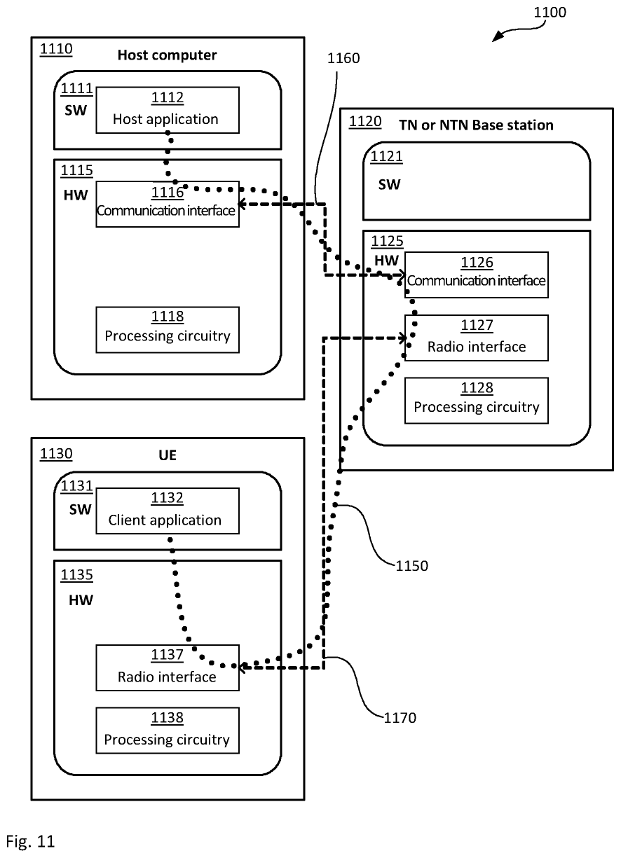

Example implementations, in accordance with an embodiment of the UE, base station and host computer discussed in the preceding paragraphs, will now be described with reference to FIG. 11. In a communication system 1100, a host computer 1110 comprises hardware 1115 including a communication interface 1116 configured to set up and maintain a wired or wireless connection with an interface of a different communication device of the communication system 1100. The host computer 1110 further comprises processing circuitry 1118, which may have storage and/or processing capabilities. In particular, the processing circuitry 1118 may comprise one or more programmable processors, application-specific integrated circuits, field programmable gate arrays or combinations of these (not shown) adapted to execute instructions. The host computer 1110 further comprises software 1111, which is stored in or accessible by the host computer 1110 and executable by the processing circuitry 1118. The software 1111 includes a host application 1112. The host application 1112 may be operable to provide a service to a remote user, such as a UE 1130 connecting via an OTT connection 1150 terminating at the UE 1130 and the host computer 1110. In providing the service to the remote user, the host application 1112 may provide user data, which is transmitted using the OTT connection 1150. The user data may depend on the location of the UE 1130. The user data may comprise auxiliary information or precision advertisements (also: ads) delivered to the UE 1130. The location may be reported by the UE 1130 to the host computer, e.g., using the OTT connection 1150, and/or by the base station 1120, e.g., using a connection 1160.

The communication system 1100 further includes a base station 1120 provided in a telecommunication system and comprising hardware 1125 enabling it to communicate with the host computer 1110 and with the UE 1130. The hardware 1125 may include a communication interface 1126 for setting up and maintaining a wired or wireless connection with an interface of a different communication device of the communication system 1100, as well as a radio interface 1127 for setting up and maintaining at least a wireless connection 1170 with a UE 1130 located in a coverage area (not shown in FIG. 11) served by the base station 1120. The communication interface 1126 may be configured to facilitate a connection 1160 to the host computer 1110. The connection 1160 may be direct, or it may pass through a core network (not shown in FIG. 11) of the telecommunication system and/or through one or more intermediate networks outside the telecommunication system. In the embodiment shown, the hardware 1125 of the base station 1120 further includes processing circuitry 1128, which may comprise one or more programmable processors, application-specific integrated circuits, field programmable gate arrays or combinations of these (not shown) adapted to execute instructions. The base station 1120 further has software 1121 stored internally or accessible via an external connection.

The communication system 1100 further includes the UE 1130 already referred to. Its hardware 1135 may include a radio interface 1137 configured to set up and maintain a wireless connection 1170 with a base station serving a coverage area in which the UE 1130 is currently located. The hardware 1135 of the UE 1130 further includes processing circuitry 1138, which may comprise one or more programmable processors, application-specific integrated circuits, field programmable gate arrays or combinations of these (not shown) adapted to execute instructions. The UE 1130 further comprises software 1131, which is stored in or accessible by the UE 1130 and executable by the processing circuitry 1138. The software 1131 includes a client application 1132. The client application 1132 may be operable to provide a service to a human or non-human user via the UE 1130, with the support of the host computer 1110. In the host computer 1110, an executing host application 1112 may communicate with the executing client application 1132 via the OTT connection 1150 terminating at the UE 1130 and the host computer 1110. In providing the service to the user, the client application 1132 may receive request data from the host application 1112 and provide user data in response to the request data. The OTT connection 1150 may transfer both the request data and the user data. The client application 1132 may interact with the user to generate the user data that it provides.

It is noted that the host computer 1110, base station 1120 and UE 1130 illustrated in FIG. 11 may be identical to the host computer 1030, one of the base stations 1012a, 1012b, 1012c and one of the UEs 1091, 1092 of FIG. 10, respectively. This is to say, the inner workings of these entities may be as shown in FIG. 11, and, independently, the surrounding network topology may be that of FIG. 10.

In FIG. 11, the OTT connection 1150 has been drawn abstractly to illustrate the communication between the host computer 1110 and the UE 1130 via the base station 1120, without explicit reference to any intermediary devices and the precise routing of messages via these devices. Network infrastructure may determine the routing, which it may be configured to hide from the UE 1130 or from the service provider operating the host computer 1110, or both. While the OTT connection 1150 is active, the network infrastructure may further take decisions by which it dynamically changes the routing (e.g., on the basis of load balancing consideration or reconfiguration of the network).

The wireless connection 1170 between the UE 1130 and the base station 1120 is in accordance with the teachings of the embodiments described throughout this disclosure. One or more of the various embodiments improve the performance of OTT services provided to the UE 1130 using the OTT connection 1150, in which the wireless connection 1170 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1150 between the host computer 1110 and UE 1130, in response to variations in the measurement results. The measurement procedure and/or the network functionality for reconfiguring the OTT connection 1150 may be implemented in the software 1111 of the host computer 1110 or in the software 1131 of the UE 1130, or both. In embodiments, sensors (not shown) may be deployed in or in association with communication devices through which the OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of the OTT connection 1150 may include message format, retransmission settings, preferred routing etc.; the reconfiguring need not affect the base station 1120, and it may be unknown or imperceptible to the base station 1120. Such procedures and functionalities may be known and practiced in the art. In certain embodiments, measurements may involve proprietary UE signaling facilitating the host computer's 1110 measurements of throughput, propagation times, latency and the like. The measurements may be implemented in that the software 1111, 1131 causes messages to be transmitted, in particular empty or “dummy” messages, using the OTT connection 1150 while it monitors propagation times, errors etc.

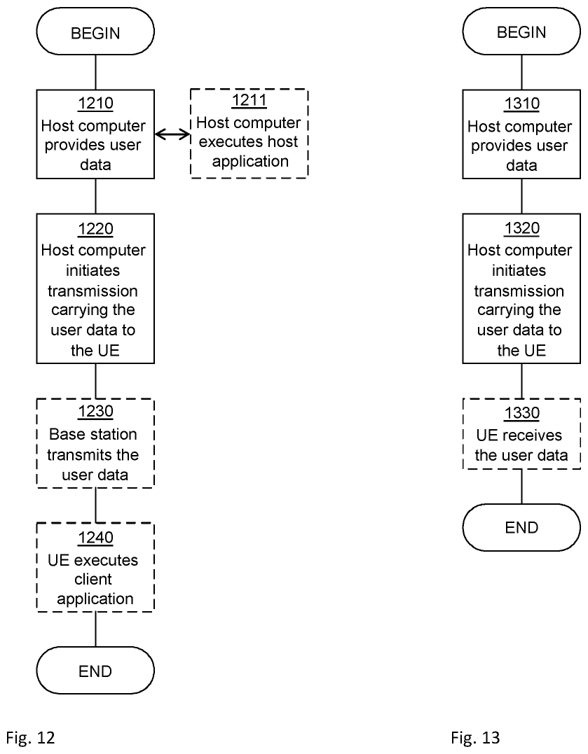

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this paragraph. In a first step 1210 of the method, the host computer provides user data. In an optional sub-step 1211 of the first step 1210, the host computer provides the user data by executing a host application. In a second step 1220, the host computer initiates a transmission carrying the user data to the UE. In an optional third step 1230, the base station transmits to the UE the user data which was carried in the transmission that the host computer initiated, in accordance with the teachings of the embodiments described throughout this disclosure. In an optional fourth step 1240, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this paragraph. In a first step 1310 of the method, the host computer provides user data. In an optional sub-step (not shown) the host computer provides the user data by executing a host application. In a second step 1320, the host computer initiates a transmission carrying the user data to the UE. The transmission may pass via the base station, in accordance with the teachings of the embodiments described throughout this disclosure. In an optional third step 1330, the UE receives the user data carried in the transmission.

As has become apparent from above description, at least some embodiments of the technique enable mobility (e.g., a handover) from a TN to an NTN (e.g., from connectivity provided by the TN to connectivity provided by the NTN) and/or from an NTN to a TN (e.g., from connectivity provided by the NTN to connectivity provided by the TN) more efficiently. For example, latency and/or handover time and/or power consumption for the handover may be reduced.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1-43. (canceled)

44. A method of supporting mobility of a radio device between a terrestrial network (TN) and a non-terrestrial network (NTN), the method comprising:
receiving a control message from at least one TN node of the TN at the radio device, the control message being indicative of at least one NTN cell of the NTN for supporting the mobility of the radio device between the TN and the NTN, wherein
the control message is further indicative of a coverage area covered by the at least one NTN node, and at least one of: a reference point of the coverage area, a center of the coverage area, or a size of the coverage area.

45. The method of claim 44, wherein
one of the at least one NTN cell is a target cell of the mobility; and
one of the at least one TN cell is a source cell of the mobility.

46. The method of claim 44, wherein
the at least one TN node of the TN provides radio access in at least one TN cell,
at least one NTN node of the NTN provides radio access in the at least one NTN cell, and
the control message is indicative of:
a position of one or each of the at least one NTN node;
a velocity of one or each of the at least one NTN node;
a trajectory of one or each of the at least one NTN node;
a cell identifier, cell ID, and/or a carrier frequency of one or each of the at least one NTN node or one or each of the at least one NTN cell;
a handover command for a handover of the radio device from the at least one TN node or the at least one TN cell to the at least one NTN node or the at least one NTN cell;
a handover command for a handover of the radio device from the at least one NTN node or the at least one NTN cell to the at least one TN node or the at least one TN cell;
a position of the radio device, optionally relative to the at least one NTN node;
an elevation angle and/or azimuth angle for an uplink transmission from the radio device to the at least one NTN node and/or a downlink reception from the at least one NTN node at the radio device;
a timing advance, TA, or a pre-compensation of the TA, for an uplink transmission from the radio device to the at least one NTN node; and/or
a precoder for a beamformed transmission from the radio device to the at least one NTN node.

47. The method of claim 44, wherein
the at least one TN cell is serving the radio device,
the at least one TN node is a serving node of the radio device, and
the at least one TN cell and the at least one NTN cell are neighboring cells or overlapping cells.

48. The method of claim 44, wherein
the at least one TN cell is a source cell of the mobility, and
the at least one NTN cell is a target cell of the mobility.

49. The method of claim 44, wherein the method further comprises:
measuring a radio signal strength, RSS, of the at least one NTN node or the at least one NTN cell and reporting the measured RSS upon request in the control message;
pointing a directional antenna of the radio device to the at least one NTN node according to the control message or applying a precoder to a plurality of antennas of the radio device for pointing a radio beam to the at least one NTN node according to the control message;
establishing or resuming a connection with the at least one NTN node or the at least one NTN cell according to the control message;
transmitting a random access preamble from the radio device to the at least one NTN node or the at least one NTN cell according to the control message; and/or
performing a handover of the radio device from the at least one TN node or the at least one TN cell to the at least one NTN node or the at least one NTN cell according to the control message.

50. The method of claim 44, wherein the control message is broadcasted in system information (SI) of the at least one TN node.

51. The method of claim 44, further comprising:
receiving system information (SI) from the at least one TN node, the SI being indicative of supporting the mobility of the radio device between the TN and the NTN and/or the availability of information as to the NTN; and
transmitting a request based on the indication in the SI to the at least one TN node, wherein the control message is received in response to the transmitted request.

52. The method of claim 44, further comprising:
searching for an NTN cell of the NTN for a predefined time period; and
if no NTN cell of the NTN is found during the predefined time period, transmitting a request to the at least one TN node, wherein the control message is received in response to the transmitted request.

53. A method of supporting mobility of a radio device between a terrestrial network (TN) and a non-terrestrial network (NTN), the method performed by the radio device comprising:
receiving a control message from at least one NTN node of the NTN at the radio device, the control message being indicative of at least one TN cell of the TN for supporting the mobility of the radio device between the TN and the NTN, wherein
the control message is further indicative of a coverage area covered by the at least one TN node, and
the control message is further indicative of: a reference point of the coverage area, a center of the coverage area, and/or a size of the coverage area.

54. The method of claim 53, wherein at least one TN node of the TN provides radio access in the at least one TN cell,
wherein the at least one NTN node of the NTN provides radio access in at least one NTN cell, and
wherein the control message is indicative of:
a location of one or each of the at least one TN node;
a cell identifier, cell ID, and/or a carrier frequency of one or each of the at least one TN node or one or each of the at least one TN cell;
a handover command for a handover of the radio device from the at least one NTN node or the at least one NTN cell to the at least one TN node or the at least one TN cell;
a handover command for a handover of the radio device from the at least one TN node or the at least one TN cell to the at least one NTN node or the at least one NTN cell;
a position of the radio device, optionally relative to the at least one TN node;
an elevation angle and/or azimuth angle for an uplink transmission from the radio device to the at least one TN node and/or a downlink reception from the at least one TN node at the radio device;
a timing advance, TA, or a pre-compensation of the TA, for an uplink transmission from the radio device to the at least one TN node; and/or
a precoder for a beamformed transmission from the radio device to the at least one TN node.

55. The method of claim 53, wherein
the at least one NTN cell is serving the radio device,
the at least one NTN node is a serving node of the radio device, and
the at least one TN node and the at least one NTN node are neighboring nodes, optionally next-neighboring nodes.

56. The method of claim 53, wherein
the at least one TN cell is a target cell of the mobility,
wherein the at least one NTN cell is a source cell of the mobility.

57. The method of claim 53, further comprising:
measuring a radio signal strength, RSS, of the at least one TN node or the at least one TN cell and reporting the measured RSS upon request in the control message;
pointing a directional antenna of the radio device to the at least one TN node according to the control message or applying a precoder to a plurality of antennas of the radio device for pointing a radio beam to the at least one TN node according to the control message;
establishing or resuming a connection with the at least one TN node or the at least one TN cell according to the control message;
transmitting a random access preamble from the radio device to the at least one TN node or the at least one TN cell according to the control message; and/or
performing a handover of the radio device from the at least one NTN node or the at least one NTN cell to the at least one TN node or the at least one TN cell according to the control message.

58. The method of claim 53, wherein the control message is broadcasted in system information (SI) of the at least one TN cell.

59. The method of claim 53, further comprising:
receiving SI from the at least one NTN node, the SI being indicative of supporting the mobility of the radio device between the TN and the NTN and/or the availability of information as to the TN; and
transmitting a request based on the indication in the SI to the at least one NTN node, wherein the control message is received in response to the transmitted request.

60. The method of claim 53, further comprising:
searching for a TN cell of the TN for a predefined time period; and
if no TN cell of the TN is found during the predefined time period, transmitting a request to the at least one NTN node, wherein the control message is received in response to the transmitted request.

61. A method of supporting mobility of a radio device between a terrestrial network (TN) and a non-terrestrial network (NTN), the method performed by at least one node of the TN or the NTN comprising:
transmitting a control message to the radio device, the control message being indicative of:
at least one NTN cell of the NTN for supporting the mobility of the radio device between the TN and the NTN, a coverage area covered by the at least one NTN node, and at least one of: a reference point of the coverage area, a center of the coverage area, or a size of the coverage area; and/or
at least one TN cell of the TN for supporting the mobility of the radio device between the TN and the NTN, a coverage area covered by the at least one TN node, and at least one of: a reference point of the coverage area, a center of the coverage area, or a size of the coverage area.

62. A radio device for supporting mobility of the radio device between a terrestrial network (TN) and a non-terrestrial network (NTN), the radio device comprising memory operable to store instructions and processing circuitry operable to execute the instructions, such that the radio device is operable to receive:
a control message from at least one TN node of the TN at the radio device, the control message being indicative of at least one NTN cell of the NTN for supporting the mobility of the radio device between the TN and the NTN, and a coverage area covered by the at least one NTN node, and at least one of: a reference point of the coverage area, a center of the coverage area, or a size of the coverage area, and/or
a control message from at least one NTN node of the NTN at the radio device, the control message being indicative of at least one TN cell of the TN for supporting the mobility of the radio device between the TN and the NTN and a coverage area covered by the at least one TN node, and at least one of: a reference point of the coverage area, a center of the coverage area, or a size of the coverage area.

63. A network node for supporting mobility of a radio device between a terrestrial network (TN) and a non-terrestrial network (NTN), the network node comprising memory operable to store instructions and processing circuitry operable to execute the instructions, such that the network node is operable to transmit a control message to the radio device, the control message being indicative of:
an NTN cell of the NTN for supporting the mobility of the radio device between the TN and the NTN, a coverage area covered by the NTN node, and at least one of: a reference point of the coverage area, a center of the coverage area, or a size of the coverage area; and/or
a TN cell of the TN for supporting the mobility of the radio device between the TN and the NTN, and a coverage area covered by the TN node, and at least one of: a reference point of the coverage area, a center of the coverage area, or a size of the coverage area.
